(19) United States
(12) Patent Application Publication
(10) Pub. No.: US 2024/0361017 A1
(43) Pub. Date: Oct. 31, 2024

(54) HUMIDIFIER

(71) Applicant: LG ELECTRONICS INC., Seoul (KR)

(72) Inventors: Sangheon LEE, Seoul (KR); Keunman PARK, Seoul (KR); Myungjin KU, Seoul (KR); Kunyoung LEE, Seoul (KR)

(21) Appl. No.: 18/647,147

(22) Filed: Apr. 26, 2024

(30) Foreign Application Priority Data
Apr. 27, 2023 (KR) 10-2023-0055145

(51) Int. Cl. F24F 6/10; F24F 6/00; F24F 6/12; F24F 11/00; F24F 11/52

(52) U.S. Cl. CPC F24F 6/10; F24F 6/12; F24F 11/0008; F24F 11/52; F24F 2006/008

(57) ABSTRACT

A humidifier includes a first humidifying water tank which heats water; and an electrical equipment unit electrically connected to the first humidifying water tank, wherein the first humidifying tank includes a heater which is disposed in a lower portion of the first humidifying water tank, and heats water, wherein the electrical equipment unit includes: a first substrate which supplies power to the heater; and a control box which accommodates the first substrate, and is electrically connected to a power cord and the heater, respectively.

### CROSS-REFERENCE TO RELATED APPLICATION(S)

This application claims priority under 35 U.S.C. § 119 to Korean Application No. 10-2023-0055145, filed in Korea on Apr. 27, 2023, whose entire disclosure(s) is/are hereby incorporated by reference.

### BACKGROUND

### 1. Field

This disclosure relates to a humidifier, and more specifically, to a humidifier in which an insulating structure is applied to a heater.

### 2. Background

A humidifier is a device that evaporates water and emits humidified air with relatively higher moisture content. A humidifier can generate humidified air by vaporizing water through various methods, such as natural evaporation, heating evaporation, or ultrasonic vibration.

A ‘humidifier’ provided in Korean Patent Publication No. 10-2023-0046632 includes: a water tank for storing water; and a main body that is disposed below the water tank. This humidifier generates humidified air using water supplied from the water tank, and the main body includes: a water storage space for storing supplied water; a vibrator disposed in a bottom surface of the water storage space; and a heater disposed in the bottom surface of the water storage space.

In this humidifier, the heater is directly exposed to the water storage space and, thus, directly contacts the water stored in the water storage space. Due to this design, a short circuit in the heater may cause electricity supplied to the heater to leak into the water stored in the water storage space, thereby potentially causing discomfort and harm to a user due to the electric leak. In addition, water leaking from the water storage space may flows inside a humidifier, thereby causing damage to electronic components mounted inside the humidifier.

The above reference is incorporated by reference herein where appropriate for appropriate teachings of additional or alternative details, features and/or technical background.

### BRIEF DESCRIPTION OF THE DRAWINGS

Embodiments will be described in detail with reference to the following drawings in which like reference numerals refer to like elements, and wherein:

FIG. 1 is a perspective view of a humidifier according to an embodiment;

FIG. 2 is a schematic diagram of a humidifier according to an embodiment;

FIG. 3 is a longitudinal cross-sectional view of a humidifier according to an embodiment;

FIG. 4 is a longitudinal cross-sectional view of a blower module of a humidifier according to an embodiment;

FIG. 5 is a perspective view of a flow path unit of a humidifier according to an embodiment;

FIG. 6 is a coupling exploded view of a flow path unit of a humidifier according to an embodiment;

FIG. 7 is a perspective view of a flow path unit and a humidifying module of a humidifier according to an embodiment;

FIG. 8 is a coupling exploded view of a middle tray, a humidifying module, and a display of a humidifier according to an embodiment;

FIG. 9 is a perspective view of a humidifying module of a humidifier according to an embodiment;

FIG. 10 is a cross-sectional view of a humidifying module of a humidifier according to an embodiment;

FIG. 11 is a perspective view of a main housing of a humidifier according to an embodiment of;

FIG. 12 is a plan view of a main housing of a humidifier according to an embodiment;

FIG. 13 is a longitudinal cross-sectional view of a humidifying module of a humidifier according to an embodiment;

FIG. 14 is a coupling exploded view of a heater of a humidifier according to an embodiment;

FIG. 15 is a coupling exploded view of a heater of a humidifier according to an embodiment;

FIG. 16 is a bottom view of a heater of a humidifier according to an embodiment;

FIG. 17 is a schematic diagram of a heating water tank of a humidifier according to an embodiment;

FIG. 18 is a exploded view of electrical equipment of a humidifier according to an embodiment;

FIG. 19 is a longitudinal cross-sectional view of electrical equipment of a humidifier according to an embodiment;

FIG. 20 is a cross-sectional perspective view of a portion of a humidifier according to an embodiment; and

FIG. 21 is a cross-sectional perspective view of a portion of a humidifier according to an embodiment.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, concepts that are well known to one of ordinary skill in the relevant art have generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another. It will be understood that when an element is referred to as being “connected with” another element, there may be intervening elements present. In contrast, it will be understood that when an element is referred to as being “directly connected with” another element, there are no intervening elements present. A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof. The direction indications of up (U), down (D), left (Le), right (Ri), front (F), rear (R), and outside (O) shown in the drawing are only for convenience of explanation, and the technical concept disclosed in this specification is not limited thereto.

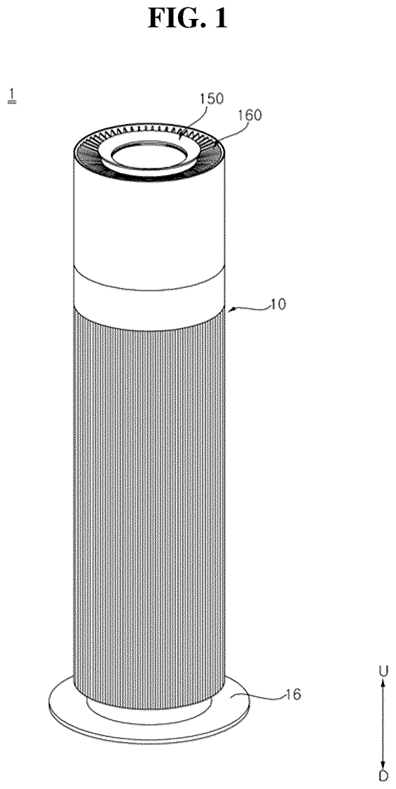

Referring to FIG. 1, certain implementations of a humidifier 1 may include a case 10, a stand 16, a discharge grill 160, and a water tank cover 150. The case 10 may form an outer shape of the humidifier 1. The case 10 may extend relatively longer in the up-down, vertical direction. For example, the case 10 may have a substantially cylindrical or other shape extending along a vertical center axis to be relatively longer in the up-down direction. The case 10 may include an internal space. A humidifying module 200 to humidify air, which will be described later, may be disposed in the internal space of the case 10.

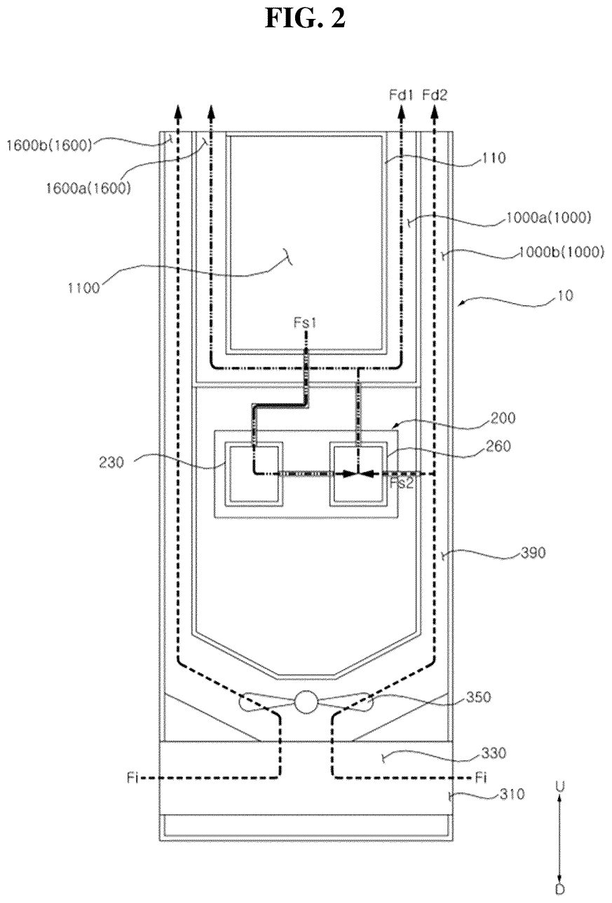

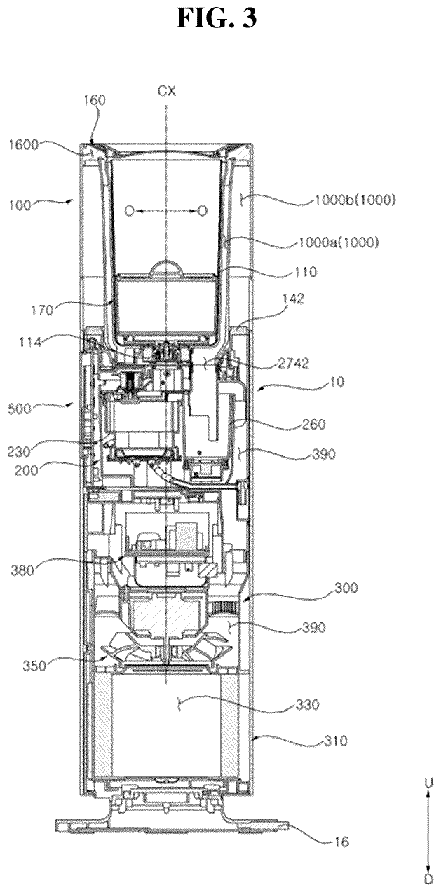

The case 10 may include a suction hole 310 (see FIG. 2). The suction hole 310 may be a through hole formed in the case 10. The suction hole 310 may be formed in a side surface of the case 10. The suction hole 310 may be formed in a portion of a circumferential surface of the case 10 having a cylinder shape. For example, the suction hole may be a through hole formed in a circumferential surface of the case 10. The case 10 may include a discharge hole 1600 (see FIG. 3). The humidified air formed within humidifier 1 may be supplied to an indoor space through the discharge hole 1600 of the case 10. The discharge hole may be formed above the case 10 or may be provided at other locations. The upper side of the case 10 may be open, and the discharge hole 1600 may be an opening formed above the case 10. For example, the discharge hole 1600 may be a substantially annular discharge hole opened in the upper surface of the cylindrical case 10. The indoor air flowing into the case 10 through the suction hole 310 may be discharged from the case 10 through the discharge hole 1600, together with humidified air.

The humidifier 1 may include a stand 16 that supports the case 10. The stand 16 may be disposed in the lower side of the case 10. The stand 16 may be fixed to the case 10. The stand 16 may improve the stability of case 10 and may help to prevent the case 10 from falling. The diameter of the stand 16 may be larger than the diameter of the case 10. The outer circumference of the stand 16 may be located radially outside of a peripheral wall of the case 10 in a horizontal direction.

The discharge grill 160 may be disposed in at least a portion of the discharge hole. The discharge grill 160 may be disposed in the open upper side of the case 10. The discharge grill 160 may be disposed within or above the discharge hole. The discharge grill 160 may form the upper surface of the case 10. Humidified air or other air flow generated within case 10 may pass through the discharge grill 160 and be supplied to the indoor space.

The water tank cover 150 may be disposed on the open upper side of the case 10. The water tank cover 150 may be disposed at the radial center of the discharge grill 160, and at least a portion of the discharge grill 160 may be disposed in the outside of the water tank cover 150. The water tank cover 150 may cover the water tank 110 (see FIG. 3) described later. The water tank cover 150 may be a lid of the water tank 110. The water tank cover 150 may be removably attached to the discharge grill 160. For example, a user may supply water to the water tank 110 by separating the water tank cover 150 from the discharge grill. After supplying water, a user may couple the water tank cover 150 to the discharge grill 160 to prevent contamination of the water and to prevent the water from spilling out from water tank 110 if case 10 is jostled or knocked over.

Referring to FIG. 2, the humidifier 1 in certain implementations may include a case 10, a water tank 110, a humidifying module 200, and a blower fan 350. The indoor air may be flowed in through a suction hole 310 formed in the case 10 (Fi). The suction hole 310 may be formed in the lower portion of the case 10. The air flowing into the inside of the case 10 may flow through the flow path formed therein (Fi). The air flowing inside the case 10 may be discharged back to the indoor space through a discharge hole 1600 formed in the upper side (Fi). Thus, air may flow vertically upwards in case 10. The humidity of the discharged air flow may be higher than the humidity of the suctioned air sucked into the suction hole 310.

The water tank 110 may store water. The water tank 110 may include a water storage space 1100 in which water is received and stored. For example, water from an external water supply may flow into the water tank 110. The water stored in the water storage space 1100 may flow to and be supplied to the humidifying module 200 (Fs1). The humidifying module 200 can generate humidified air using supplied water.

The humidifying module 200 may generate humidified air. Humidified air may include mist and/or water vapor. For example, humidified air may refer to air including water droplets and/or evaporated water. The humidity of humidified air may be relatively higher than the humidity of ambient indoor air.

The humidifying module 200 may include a first humidifying water tank (or first tank) 230. Water supplied from the water tank 110 may flow into the first humidifying water tank 230 (Fs1). Water in the first humidifying water tank 230 may be supplied from the water tank 110 and may be heated. For example, water in the first humidifying water tank 230 may be heated to sterilize the supplied water. Additionally, water in the first humidifying water tank 230 may be heated such that a portion of the water is evaporated to form water vapor.

The humidifying module 200 may include a second humidifying water tank (or second tank) 260. The water sterilized in the first humidifying water tank 230 may move to the second humidifying water tank 260 (Fs1). The second humidifying water tank 260 may utilize water supplied from the first humidifying water tank 230 to generate humidified air. The second humidifying water tank 260 may generate humidified air by using one or more of an ultrasonic method, a heating method, an evaporation method, and/or a disk method. For example, the second humidifying water tank 260 may generate humidified air by atomizing the supplied water using an ultrasonic vibrator.

The blower fan 350 may be disposed inside the case 10. The blower fan 350 may be disposed below the humidifying module 200. The blower fan 350 may form an air current that flows upwards and inside the case. The blower fan 350 may form an airflow flowing from the suction hole 310 to the discharge hole 1600 (Fi). For example, the blower fan 350 may form a rising airflow that flows from the suction hole 310 formed in the lower portion of the case 10 to the discharge hole 1600 formed in the upper surface of the case 10.

The case 10 may include a blowing flow path 390 to receive at least a portion of air flowing from fan 350. The blowing flow path 390 may be formed inside the case 10. The blowing flow path 390 may be a flow path through which air blowing from the blower fan 350 flows. Air may be suctioned and flow into the case 10 in through the suction hole 310 and may flow to the blower fan 350 through the suction flow path 330 (Fi). The air received at the blower fan 350 may be pressurized to flow into the blowing flow path 390 (Fi), such as in an upward direction from blower fan 350.

The case 10 may include a discharge flow path 1000. The discharge flow path 1000 may be formed inside the case 10. The air passed through the blowing flow path 390 may flow to the discharge flow path 1000 (Fd). The discharge flow path 1000 may be located at an upper side of the blowing flow path 390. The discharge flow path 1000 may be located downstream of the blowing flow path 390.

The discharge flow path 1000 may include a first discharge flow path (also referred to as an inner or humidified discharge flow path) 1000a and a second discharge flow path (also referred to as an outer or non-humidified discharge flow path) 1000b. The discharge hole 1600 may include a first discharge hole 1600a corresponding to the first discharge flow path 1000a, and a second discharge hole 1600b corresponding to the second discharge flow path 1000b. The second discharge flow path 1000b may be formed radially inside of the case 10. The first discharge flow path 1000a may be formed radially inside of the second discharge flow path 1000b. The second discharge flow path 1000b may be connected to the blowing flow path 390. The second discharge flow path 1000b may be located downstream of the blowing flow path 390 and may receive air that bypasses the humidifying module 200. Some of the air passed through the blowing flow path 390 may bypass the humidifying module 200 and rise through the second discharge flow path 1000b (Fd2). The air passed through the second discharge flow path 1000b may be supplied to the indoor space through the second discharge hole 1600b (Fd2). Some of a remaining portion of the air that passed through the blowing flow path 390 may flow into the humidifying module 200 (Fs2). For example, some of the remaining portion of the air passed through the blowing flow path 390 may flow into the second humidifying water tank 260 for humidification (Fs2). Humidified air in the second humidifying water tank 260 may flow into the first discharge flow path 1000a (Fd1). The humidified air flowing through the first discharge flow path 1000a may be supplied to the indoor space through the first discharge hole 1600a (Fd1).

Referring to FIG. 3, the humidifier 1 may include a blower module 300, a humidifying module 200, a flow path unit 100, a display 500, and an electrical equipment unit 380. The blower module 300 may be disposed inside the case 10, and the blower module 300 may form an airflow flowing inside the case 10. The blower module 300 may flow indoor air into the case 10 through the suction hole 310. The blower module 300 may blow the sucked air to the humidifying module 200 and/or the flow path unit 100. The blower module 300 may form an airflow that pulls the humidified air generated by the humidifying module 200. The blower module 300 may cause discharge humidified air generated by the humidifying module 200 to the indoor space.

The humidifying module 200 may generate humidified air. The humidifying module 200 may be disposed inside the case 10. The humidifying module 200 may be disposed above the blower module 300 to receive a portion of an air flow from the blower module 300. The humidifying module 200 may generate and discharge humidified air. A portion of the rising airflow formed from the blower module 300 may be directed to the humidifying module 200 through the blowing flow path 390. The rising airflow may pull the humidified air generated by the humidifying module 200 upward. The humidified air may be discharged through the discharge hole 1600 along with a rising airflow.

A flow path unit 100 may include a discharge flow path through which air is discharged from case 10. The flow path unit 100 may include a discharge flow path 1000. The discharge flow path 1000 may include a first discharge flow path 1000a and a second discharge flow path 1000b. Humidified air generated by the humidifying module 200 may flow to the first discharge hole 1600a through the first discharge flow path 1000a, and the humidified air may be supplied to the indoor space through the first discharge hole 1600a. A portion of the air flowing in the blowing flow path 390 may bypass the humidifying module 200 and flow to the second discharge hole 1600b through the second discharge flow path 1000b without being humidified. The portion of non-humidified air is supplied to the indoor space through the second discharge hole 1600b.

The display 500 may display information on the humidifier 1. The display 500 may include an output unit that displays information on the humidifier 1 to a user. Information on the humidifier 1 may include status information, such as the level of water stored in the water tank 110, the amount of humidification discharged, the temperature and humidity of the indoor space, the quality of air in the indoor space, the concentration of fine dust in the indoor space, and the like. In another example, the display 500 may selectively output light of at least one color to indicate a status of the humidifier 1 (e.g., output blue light when the humidifier 1 is properly operating and a red light when the humidifier needs servicing). The display 500 may include an input unit such as a touch screen or buttons through which a user's command is received. A user may control the operation of the humidifier 1 through the display 500. For example, a user may control the humidification amount, air volume, operation time, turn on-off of lighting, the intensity of lighting, etc. through the display 500.

The electrical equipment unit 380 may transmit and receive electrical signals. The electrical equipment unit 380 may control the operation of the humidifier 1. The electrical equipment unit 380 may control the power supplied to components of the humidifier 1. The electrical equipment unit 380 may include, for example, a printed circuit board (PCB) having circuitry, such as one or more processing units, provided on a substrate.

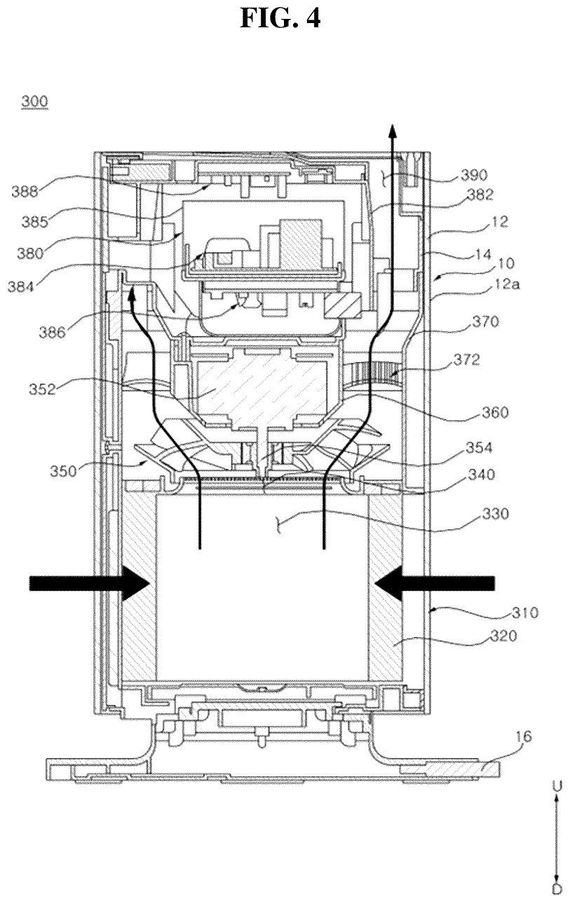

Referring to FIG. 4, the blower module (or blower) 300 in certain implementations of humidifier 1 may include a filter 320, a blower fan 350, and a blower motor 352. The indoor air within case 10 may be sucked into the blower module 300 through the suction hole 310 formed in the case 10. The blower module 300 may include a filter 320 that filters the sucked air. The filter 320 may be disposed inside the case 10. For example, the filter 320 may be disposed inside the cylindrical case 10, and may be formed in a substantially cylindrical or other shape to fit within case 10. The air passed through the filter 320 may flow to the blower fan 350 through the suction flow path 330. The suction flow path 330 may be formed inside the filter 320.

The blower module 300 may include an orifice 340 located between the blower fan 350 and the filter 320. The orifice 340 may be a hole through which the suction air passes. The orifice 340 may be located between the suction flow path 330 and the blowing flow path 390. The orifice 340 may communicate with the suction flow path 330 and the blowing flow path 390. The orifice 340 may correspond to an inlet formed in the blower fan 350, such as an inlet formed in a shroud of the blower fan 350. The suction air may flow from the suction flow path 330 to the blower fan 350 through the orifice 340, and may flow to the blowing flow path 390 by rotation of the blower fan 350.

The blower module 300 may include a blower motor 352 that rotates the blower fan 350. The blower motor 352 may be connected to and drive the blower fan 350. For example, a shaft 354 of the blower motor 352 may be connected to the blower fan 350. The blower motor 352 may be disposed above the blower fan 350. The shaft 354 may extend downward from the blower motor 352, and may be connected to a hub of the blower fan 350 to provide a rotating force to the blower fan 350. As the blower motor 352 is driven, e.g., from a driving current from the electrical equipment unit 380, the blower fan 350 may rotate to form an airflow.

The blower module 300 may include a motor cover 360 defining a space in which the blower motor 352 may be disposed. The blower motor 352 may be accommodated in that space of the motor cover 360. Inside the motor cover 360, the blower motor 352 may be disposed, and the blower fan 350 may be disposed outside the motor cover 360. For example, the blower fan 350 may be disposed under the motor cover 360. The shaft 354 of the blower motor 352 may penetrate the motor cover 360.

The blower module 300 may include a blower housing 370 that forms a blowing flow path 390. The blower housing 370 may be disposed inside the case 10. The blower fan 350 and the blower motor 352 may be disposed inside the blower housing 370. The blowing flow path 390 may be formed between the motor cover 360 and the blower housing 370. The blower housing 370 may extend in the up-down, vertical direction.

The case 10 may include an inner case 14 and an outer case 12. The outer case 12 may form the outer appearance and shape of the case 10. The outer case 12 may include a plurality of louvers 12a. The plurality of louvers 12a may be disposed along the circumference of the outer case 12. The inner case 14 may be disposed inside the outer case 12. At least a portion of the inner case 14 may be disposed above the blower housing 370. For example, the inner case 14 and the blower housing 370 may be disposed inside the outer case 12, and the inner case 14 may be coupled to an upper side or surface of the blower housing 370.

The blowing flow path 390 may be formed inside the case 10. The blowing flow path 390 may extend in the up-down, vertical direction inside the case 10. The blowing flow path 390 may have a substantially annular shaped cross-section. The blowing flow path 390 may be located downstream of the blower fan 350. The blower fan 350 may be located between the suction flow path 330 and the blowing flow path 390. The motor cover 360 may be disposed inside the blower housing 370. The blowing flow path 390 may be formed between the motor cover 360 and the blower housing 370.

The electrical equipment unit 380 may be disposed above the blower motor 352. The electrical equipment unit 380 may be disposed inside the inner case 14. A blowing flow path 390 may be formed between the electrical equipment unit 380 and the inner case 14. Accordingly, the sucked air may be directed to the humidifying module 200 along the blowing flow path 390 by the blower fan 350.

The blower module 300 may include an air diffuser 372 disposed in the blowing flow path 390. The air diffuser 372 may control the directionality of the airflow flowing in the blowing flow path 390. For example, the air diffuser 372 may straighten the airflow flowing through the blowing flow path 390. The air diffuser 372 may be disposed outside of the motor cover 360. The air diffuser 372 may be disposed inside the blower housing 370. For example, the air diffuser 372 may include a plurality of air diffusers 372 disposed between the motor cover 360 and the blower housing 370, and the plurality of air diffusers 372 may be disposed to be spaced apart from each other in the circumferential direction of the cross section of the blowing flow path 390. A flow path may be formed between the plurality of air diffusers 372.

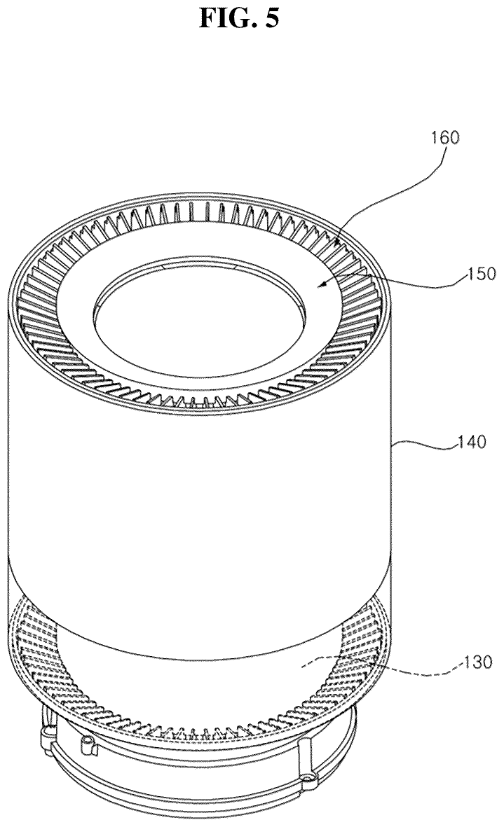

Referring to FIG. 5, the flow path unit 100 in certain implementations of humidifier 1 may include a shell including inner shell 130 and outer shell 140, a discharge grill 160, and a water tank cover 150. The flow path unit 100 may include the shell 130, 140. The case 10 may include the shell 130, 140. The shell 130, 140 may form the outer shape of the flow path unit 100. The shell 130, 140 may have an accommodation space formed therein. The water tank 110 may be accommodated in the shell 130, 140. The discharge flow path 1000 may be formed inside the shell 130, 140. At least a portion of the upper side of the shell 130, 140 may be open. The discharge hole 1600 may be formed in the upper side of the shell 130, 140.

The discharge grill 160 may be disposed above the shell 130, 140. The discharge grill 160 may be disposed at the discharge hole 1600. The discharge grill 160 may be disposed in the upper end of the shell 130, 140. For example, the discharge grill 160 may extend along the inner circumference of the upper end of the shell 130, 140. The discharge grill 160 may include a plurality of vanes.

The water tank cover 150 may be disposed above the shell 130, 140. The water tank cover 150 may cover the open upper side of the water tank 110. The water tank cover 150 may open or close the water tank 110. The water tank cover 150 may be disposed inside the discharge grill 160. The water tank cover 150 may be disposed in the center of the annular discharge grill 160. For example, the water tank 110 may be disposed in the center of the shell 130, 140, and the water tank cover 150 may cover the open upper side of the water tank 110.

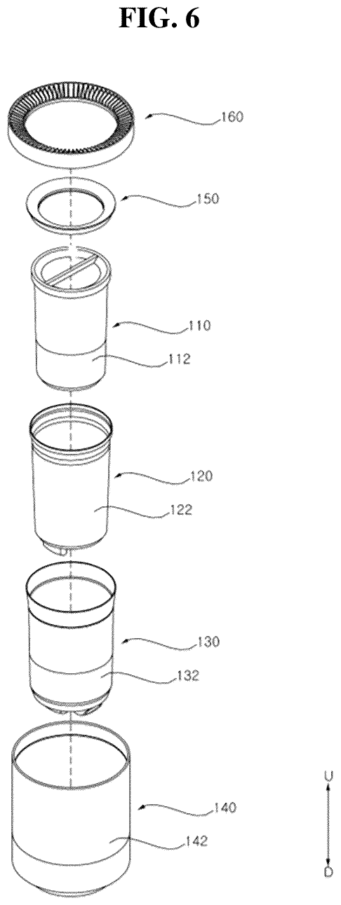

Referring to FIG. 6, the flow path unit 100 in certain implementations of humidifier 1 may include a water tank 110, a water tank cover 150, a water tank housing 120, an inner shell 130, an outer shell 140, and a discharge grill 160. The water tank 110 may be formed in a substantially cylindrical or other shape. The water tank 110 may extend in the up-down direction. The water tank 110 may have a water storage space 1100 formed therein. The discharge grill 160 may extend along the circumference of the upper end of the water tank 110. The discharge grill 160 may be disposed outside the upper end of the water tank 110. The water tank 110 may include a water tank circumference wall 112 that forms an outer shape. The water tank peripheral wall 112 may partition the water storage space 1100 of the water tank 110.

The water tank housing 120 may define a space to accommodate the water tank 110. The water tank housing 120 may have an internal space where the water tank 110 is disposed. The water tank housing 120 may surround at least a portion of the water tank 110. The water tank housing 120 may be a holder of the water tank 110. The water tank housing 120 may cover at least a portion of the water tank peripheral wall 112 of the water tank 110. At least a portion of the water tank 110 may be fitted into the water tank housing 120. The water tank peripheral wall 112 may be in relatively close contact with the inner peripheral wall of the water tank housing 120. The water tank housing 120 may fix the inserted water tank 110 so that it does not move in the horizontal direction. The water tank housing 120 may be maintained horizontally so that the water tank 110 does not tip over inside the case 10. The water tank housing 120 and the water tank 110 may be separated from the case 10, respectively. The water tank housing 120 may include a housing peripheral wall 122 that extends vertically in a circumferential direction and partitions the internal space around water tank housing 120.

The shell 130, 140 may include the inner shell 130. The case 10 may include the inner shell 130. The inner shell 130 may accommodate the water tank 110 and/or the water tank housing 120. The inner shell 130 may be spaced apart from the water tank 110 and/or the water tank housing 120 in an outward direction. A portion of the first discharge flow path 1000a may be formed between the inner shell 130 and the water tank housing 120. In another example, a portion of the first discharge flow path 1000a may be formed between the water tank 110 and the inner shell 130. A portion of the second discharge flow path 1000b may be formed between the inner shell 130 and the inner surface of the case 10. The humidified air generated from the humidifying module 200 may flow through the first discharge flow path 1000a. The inner shell 130 may partition portions the first discharge flow path 1000a and the second discharge flow path 1000b. The inner shell 130 may include an inner peripheral wall 132 that extends vertically in a circumferential direction and partitions the internal space around inner shell 130.

The shell 130, 140 may include the outer shell 140. The case 10 may include the outer shell 140. The outer shell 140 may form the outer shape of the flow path unit 100. The outer shell 140 may have an internal space. The upper side of the outer shell 140 may be open. The outer shell 140 may accommodate the water tank 110, the water tank housing 120, and/or the inner shell 130. The outer shell 140 may be spaced outwardly from the water tank 110, the water tank housing 120, and/or the inner shell 130. The discharge flow path 1000 may be formed inside the outer shell 140. The discharge flow path 1000 may be formed between the outer shell 140 and the water tank 110. For example, the first discharge flow path 1000a may be formed between the water tank housing 120 and the inner shell 130, and the second discharge flow path 1000b may be formed between the inner shell 130 and the outer shell 140. The outer shell 140 may include an outer peripheral wall 142 that that extends vertically in a circumferential direction and partitions the internal space around outer shell 140.

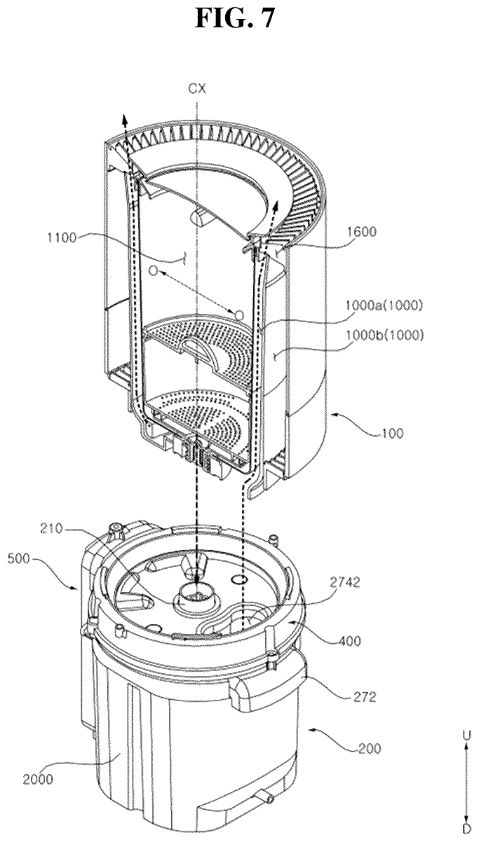

Referring to FIG. 7, the humidified air discharged from the humidifying module 200 included in certain implementations of humidifier 1 may be discharged through the flow path unit 100. The humidifying module 200 may include a main housing 2000, a supply pipe 210, and a humid air outlet 2742. The main housing 2000 may form the outer shape of the humidifying module 200.

The water stored in the water storage space 1100 may flow into the humidifying module 200 through the supply pipe 210. The humidifying module 200 may generate humidified air by using water supplied through the supply pipe 210. The supply pipe 210 may be disposed above the humidifying module 200. The supply pipe 210 may extend upward from an upper surface of the humidifying module 200. For example, the water stored in the water storage space 1100 located above the humidifying module 200 may flow in through the supply pipe 210 disposed above the humidifying module 200 and below the water storage space 1100.

The humidified air generated in the humidifying module 200 may be discharged through the humid air outlet 2742. The humid air outlet 2742 may be formed above the humidifying module 200. The humid air outlet 2742 may be an opening formed on the upper surface of the humidifying module 200.

The middle tray 400 may be disposed above the humidifying module 200. The middle tray 400 may be coupled to the upper surface of the humidifying module 200. The middle tray 400 may be disposed between the humidifying module 200 and the flow path unit 100.

The display 500 may be disposed in one side of the humidifying module 200. A portion of the display 500 may be coupled to one side of the main housing 2000. A portion of the display 500 may be coupled to one side of the middle tray 400. For example, the middle tray 400 may be disposed in the upper surface of the humidifying module 200, and the display 500 may be disposed in the side surface of the humidifying module 200.

The flow path unit 100 may include a water storage space 1100, a discharge flow path 1000, and a discharge hole 1600. The water storage space 1100 may be formed inside the flow path unit 100. The water stored in the water storage space 1100 may be supplied to the humidifying module 200. For example, the water stored in the storage space 1100 may flow into the humidifying module 200 through the supply pipe 210 located under the storage space 1100.

The discharge flow path 1000 may be located inside the flow path unit 100. The discharge flow path 1000 may be located radially around and outside the water storage space 1100. The discharge flow path 1000 may be located between the peripheral wall of the flow path unit 100 and the water storage space 1100. The discharge flow path 1000 may include a first discharge flow path 1000a located radially outside the water storage space 1100 and a second discharge flow path 1000b located radially outside the first discharge flow path 1000a. The first discharge flow path 1000a may be located radially between the water storage space 1100 and the second discharge flow path 1000b. The second discharge flow path 1000b may be located radially between the first discharge flow path 1000a and the peripheral wall of the flow path unit 100.

The humidified air discharged from the humidifying module 200 may flow through at least a portion of the discharge flow path 1000. For example, the humidified air discharged from the humid air outlet 2742 may flow through the first discharge flow path 1000a. The humidified air flowing through the first discharge flow path 1000a may be supplied to the indoor space through the discharge hole 1600. The first discharge flow path 1000a and the second discharge flow path 1000b may be joined at or below the discharge hole 1600. The first discharge flow path 1000a may be connected to the humid air outlet 2742 to receive the humidified air from humidifying module 200. The second discharge flow path 1000b may be connected to the blowing flow path 390 to receive air that bypassed humidifying module 200.

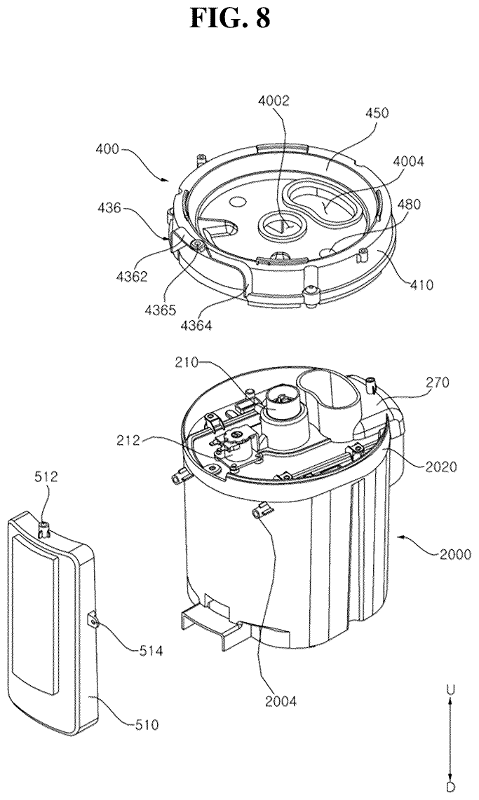

Referring to FIG. 8, the middle tray 400 in certain implementations of humidifier 1 may be coupled to the upper surface of the humidifying module 200, and the display 500 may be coupled to the side surface of the humidifying module 200 and the middle tray 400. For example, the middle tray 400 may be seated on the upper side of the humidifying module 200. The supply pipe 210 of the humidifying module 200 may penetrate pass through an opening in the middle tray 400. The supply pipe 210 of the humidifying module 200 may be disposed in a middle inlet 4002 of the middle tray 400. The middle tray 400 may include a middle outlet 4004 corresponding to the humid air outlet 2742 of the humidifying module 200, and humidified air from humidifying module 200 may pass through middle outlet 4004 to be outputted through the discharge hole 1600.

The display 500 may be coupled to the side surface of the humidifying module 200. The middle tray 400 may be coupled to an upper side of the humidifying module 200, and the display 500 may be coupled to the side surface of the middle tray 400 and the side surface of the humidifying module 200.

The display 500 may include a display housing 510 that forms the outer shape of the display 500. The one side of the display housing 510 may be open. The other side of the display housing 510 may be closed. The open side and the closed side of the display 500 may face each other. For example, one side (e.g., a rear side) of the display housing 510 facing the humidifying module 200 may be open, and the other side (e.g., a front side) that is opposite to the open side and that faces the outside may be closed.

The middle tray 400 may include a coupling cover 436. The coupling cover 436 may extend from the side surface of the middle tray 400. The coupling cover 436 may cover a portion of the rear, open side surface of the display housing 510. The coupling cover 436 may correspond to the open side surface of the display housing 510.

The coupling cover 436 may include an upper cover 4362 that covers the upper surface of the display housing 510. The upper cover 4362 may cover at least a portion of the upper surface of the display housing 510. The upper cover 4362 may cover a gap formed between the display housing 510 and the middle tray 400.

The coupling cover 436 may include a side cover 4364 that covers the side surface of the display housing 510. The side cover 4364 may extend from upper cover 4362. For example, the side cover 4364 may extend downward from the upper cover 4362. The side cover 4364 may cover at least a portion of the side surface of the display housing 510. The side cover 4364 may cover a gap formed between the display housing 510 and the middle tray 400.

The display 500 may be coupled to the middle tray 400. The display housing 510 may be fastened to the middle tray 400. The upper surface of the display housing 510 may be fastened to the upper cover 4362. The upper cover 4362 may include a first upper fastening portion (or first upper fastening region) 4365. The display housing 510 may include a second upper fastening portion (or second upper fastening region) 512 formed on the upper surface. The second upper fastening portion 512 may correspond to the first upper fastening portion 4365. For example, the first upper fastening portion 4365 and the second upper fastening portion 512 may be screw fastened or coupled using another method, such as by an adhesive or be welding.

The display 500 may be coupled to the humidifying module 200. The display housing 510 may be fastened to the side surface of the main housing 2000. The main housing 2000 may include a first side fastening portion 2004. The display housing 510 may include a second side fastening portion 514 formed on a side surface. The second side fastening portion 514 may correspond to the first side fastening portion 2004. For example, the first side fastening portion 2004 and the second side fastening portion 514 may be screw fastened or otherwise coupled.

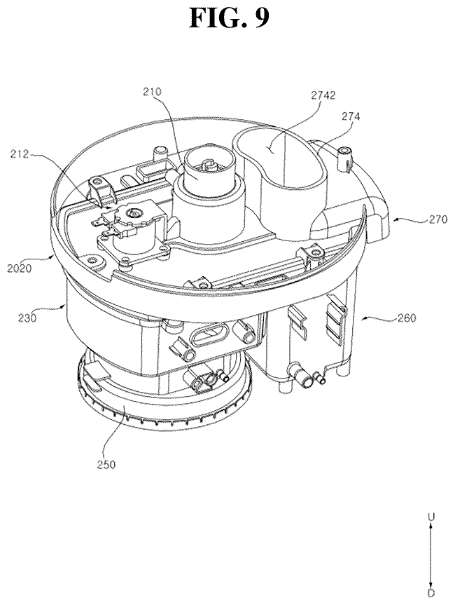

Referring to FIG. 9, the humidifying module 200 in certain implementations of the humidifier 1 may include a first humidifying water tank 230 that heats supplied water, a second humidifying water tank 260 that generates humidified air by using supplied water, a main cover 2020 covering the first humidifying water tank 230 and the second humidifying water tank 260, and a compartment cover 270 coupled to the main cover 2020.

The first humidifying water tank 230 may include a heater 250 that heats stored water. The heater 250 may be disposed in a lower side of the first humidifying water tank 230. For example, the heater 250 may form at least a portion of the bottom surface of the first humidifying water tank 230. The second humidifying water tank 260 may be disposed at one side of the first humidifying water tank 230. The second humidifying water tank 260 may receive heated and sterilized water from the first humidifying water tank 230.

A main cover (or partition) 2020 may be disposed above the first humidifying water tank 230 and the second humidifying water tank 260. The main cover 2020 may cover the open upper side of the first humidifying water tank 230 and the open upper side of the second humidifying water tank 260. The main cover 2020 may be fixed to the first humidifying water tank 230 and the second humidifying water tank 260. The middle tray 400 may be coupled to a lower surface of the main cover 2020.

The compartment cover 270 may be fixed to the main cover 2020. A portion of the compartment cover 270 may be disposed in the second humidifying water tank 260. The compartment cover 270 may guide the input airflow flowing through the blowing flow path 390 toward the inside of the second humidifying water tank 260. Additionally or alternatively, the compartment cover 270 may discharge humidified air generated in the second humidifying water tank 260 upward. The compartment cover 270 may include a discharge pipe 274 disposed at the second humidifying water tank 260. The compartment cover 270 may include a humid air outlet 2742 that opens upward, such as to guide humidified air toward discharge port 1600. The humid air outlet 2742 may be formed in one end of the discharge pipe 274.

The supply pipe 210 may protrude upward from the main cover 2020. The humidifying module 200 may include a first valve 212 that opens or closes a flow path through which water flows into the first humidifying water tank 230 through the supply pipe 210. The first valve 212 may be disposed above the main cover 2020.

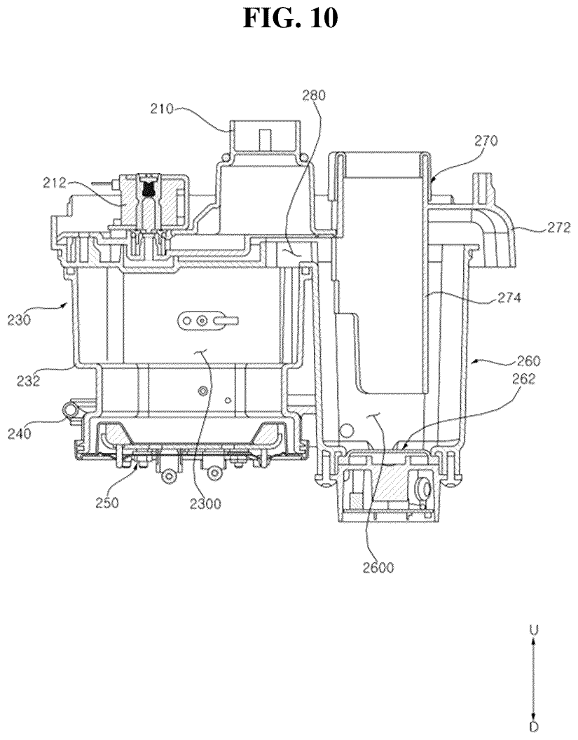

Referring to FIG. 10, the humidifying module 200 in certain implementations of humidifier 1 may include a supply pipe 210, a first valve 212, a first humidifying water tank 230, a first connection pipe 240, a second humidifying water tank 260, and a compartment cover 270.

As previously described, the supply pipe 210 may be a pipe through which water is supplied to the humidifying module 200. The supply pipe 210 may be connected to the first humidifying water tank 230 or the second humidifying water tank 260. The water stored in the water tank 110 may be supplied to the humidifying module 200 through the supply pipe 210. For example, the water stored in the water tank 110 may be moved to the first humidifying water tank 230 through the supply pipe 210. A supply chamber 2100 may be formed inside the supply pipe 210. The water flowing into the supply pipe 210 may pass through the supply chamber 2100 and flow into the first humidifying water tank 230. The water flowing into the supply pipe 210 may be temporarily stored in the supply chamber 2100.

The first valve 212 may control the flow of water supplied to the humidifying module 200 through the supply pipe 210. For example, when the first valve 212 is opened, the water stored in the supply chamber 2100 may move to the first humidifying water tank 230. Conversely, when the first valve 212 is closed, the supplied water may be temporarily stored in the supply chamber 2100. The first valve 212 may be opened and closed according to an electrical signal from the electrical equipment unit 380. The first valve 212 may receive power from the electrical equipment unit 380. For example, the first valve 212 may be a solenoid valve. The first valve 212 may be disposed above the first humidifying water tank 230. The first valve 212 may be disposed in the supply pipe 210. For example, the first valve 212 may be disposed between the first humidifying water tank 230 and the supply pipe 210. The first valve 212 may be spaced upward from the first humidifying water tank 230. For example, the first valve 212 may be disposed to be spaced upward from the upper surface of the first humidifying water tank 230.

The first humidifying water tank 230 may be disposed inside the main housing 2000. The first humidifying water tank 230 may receive water through the supply pipe 210 and this water may be heated by heater 250. The first humidifying water tank 230 may include or otherwise define a first chamber 2300 in which water is stored. The water stored in the first chamber 2300 may be heated. The first humidifying water tank 230 may include a first humidifying water tank wall 232 that partitions or defines the first chamber 2300. The first humidifying water tank 230 may sterilize water by heating it. The water heated and sterilized in the first humidifying water tank 230 may flow into the second humidifying water tank 260. The first humidifying water tank 230 may include a heater 250 that heats water stored in the first chamber. The heater 250 may be provided at or form the lower surface of the first humidifying water tank wall 232. The heater 250 may form the bottom surface of the first chamber 2300. For example, the heater 250 and the first humidifying water tank wall 232 may partition the first chamber 2300 that opens upward.

The second humidifying water tank 260 may generate humidified air by using the supplied water from the first humidifying water tank 230. The humidified air may refer to air containing mist and/or water vapor. The second humidifying water tank 260 may generate humidified air by using, for example, one or more of an ultrasonic method, a heating method, an evaporation method, and a disk method. For example, the second humidifying water tank 260 may generate humidified air by atomizing supplied water by using an ultrasonic vibrator 262. The humidifying water tank may have an ultrasonic vibrator 262. The second humidifying water tank 260 may include or otherwise define a second chamber 2600 in which humidified air is generated.

The first connection pipe 240 may be a pipe through which water stored in the first humidifying water tank 230 flows toward the second humidifying water tank 260. The first connection pipe 240 may connect the first chamber 2300 and the second chamber 2600. The height of the first connection pipe 240 may decrease as it extends downstream between the first chamber 2300 and the second chamber 2600. The first connection pipe 240 may be inclined downward toward the downstream side. The first connection pipe 240 may be composed of metal or other material to have a relatively high thermal conductivity. The temperature of water heated in the first humidifying water tank 230 may be lowered while flowing through the first connection pipe 240 by thermal conduction to the first connection pipe 240.

The ultrasonic vibrator 262 may be disposed on the bottom surface of the second humidifying water tank 260. The ultrasonic vibrator 262 may be disposed at the lower side of the second chamber 2600. The ultrasonic vibrator 262 may atomize the supplied water into fine particles by using ultrasonic vibration. The ultrasonic vibrator 262 may be electrically driven by electrical equipment unit 380 to atomize water. For example, the ultrasonic vibrator 262 may include a piezoelectric element that vibrates based on receiving a driving signal from the electrical equipment unit 380.

The compartment cover 270 may be disposed above the main housing 2000. The compartment cover 270 may cover the upper side of the second humidifying water tank 260. The compartment cover 270 may partition a flow path flowing into the second humidifying water tank 260 and a flow path flowing out from the second humidifying water tank 260. For example, the compartment cover 270 may include an air supply pipe 210 providing a input flow path through which a portion of the rising airflow flowing through the blowing flow path 390 flows into the second humidifying water tank 260, and a discharge pipe 274 through which a portion of the rising airflow flowing into the second humidifying water tank 260 and the mist formed in the second humidifying water tank 260 are discharged together out of the second humidifying water tank 260. The air supply pipe 210 may connect the blowing flow path 390 and the second humidifying water tank 260.

The rising airflow that flowed in the second humidifying water tank 260 through the blowing flow path 390 may carry the mist generated in the second humidifying water tank 260. Through this output airflow, the mist generated in the second humidifying water tank 260 may be discharged. The discharge pipe 274 may extend in a vertical direction. The discharge pipe 274 may form a discharge flow path 2740. The humid air outlet 2742 may be formed in one end of the discharge pipe 274. A portion of the discharge pipe 274 may be inserted into the second humidifying water tank 260, such as to provide an input end of the second humidifying water tank 260 within second chamber 2600 in which mist/water vapor is present.

The humidifying module 200 may include a communication flow path 280 that connects the first humidifying water tank 230 and the second humidifying water tank 260. The communication flow path 280 may connect the upper portion of the first humidifying water tank 230 and the upper portion of the second humidifying water tank 260. In the first humidifying water tank 230, water vapor may be generated in the process of heating supplied water. The generated water vapor may flow into the second humidifying water tank 260 through the communication flow path 280. The discharge pipe 274 may be open toward the communication flow path 280. The communication flow path 280 may be connected to the discharge flow path 2740. The water vapor that moves from the first humidifying water tank 230 to the second humidifying water tank 260 through the communication flow path 280 may be discharged through the discharge pipe 274. Through this configuration, the humidified air may include water vapor generated in the first humidifying water tank 230, mist generated in the second humidifying water tank 260, and a rising airflow formed by the blower fan 350.

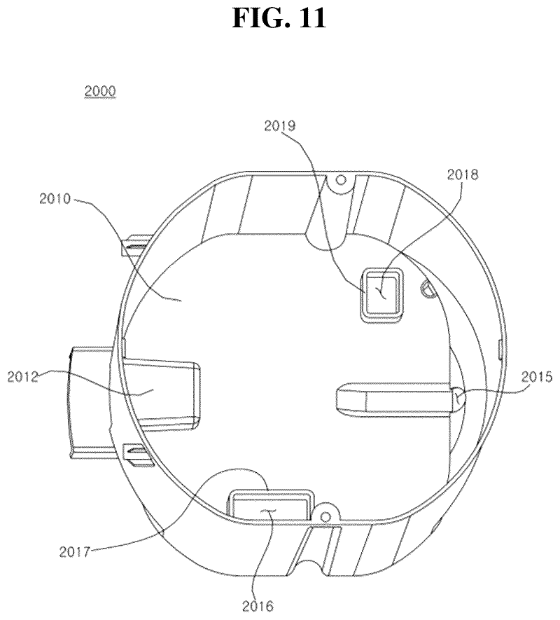

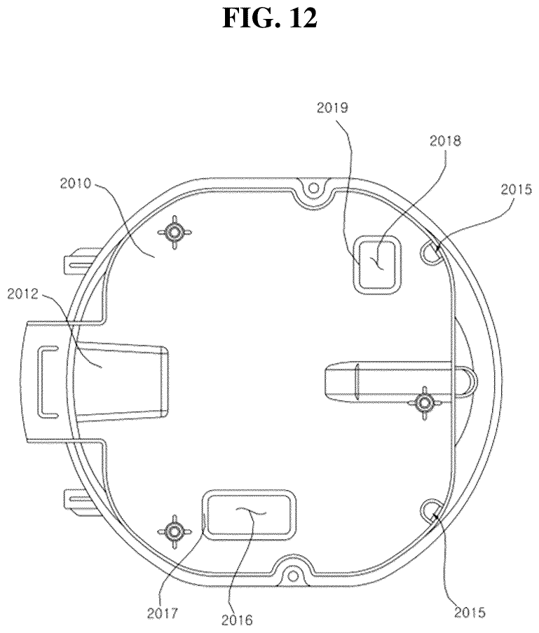

Referring to FIGS. 11 and 12, the humidifying module 200 in certain implementations of humidifier 1 may include a main housing 2000 that accommodates the first humidifying water tank 230 and the second humidifying water tank 260. The main housing 2000 may be disposed inside the case 10. The main housing 2000 may accommodate the first humidifying water tank 230 and the second humidifying water tank 260. The upper side of the main housing 2000 may be open.

The main housing 2000 may include a housing recess 2012 recessed from the bottom surface, a base opening 2016, 2018 penetrating the bottom surface, and a drain hole 2015 through which residual water is discharged. The main housing 2000 may include a housing base 2010, which corresponds to a bottom surface of the main housing 2000. One surface of the housing base 2010 may define the inner bottom surface of the main housing 2000, and the other surface of the housing base 2010 may define the outer bottom surface of the main housing 2000.

The housing recess 2012 may be recessed upward from the housing base 2010. The housing recess 2012 may be located on upper side than the housing base 2010. The housing recess 2012 may protrude from housing base 2010. For example, the housing recess 2012 may protrude upward from the housing base 2010.

The base openings 2016, 2018 may be through holes defined at the main housing 2000. The base opening 2016, 2018 may be defined at the housing base 2010. The base opening 2016, 2018 may communicate the inner space of the main housing 2000 with the inner space of an electrical equipment housing 382. The base opening 2016, 2018 may include a first base opening 2016 and a second base opening 2018. The first base opening 2016 and the second base opening 2018 may be spaced apart from each other. The electrical equipment unit 380 and the humidifying module 200 may be electrically connected through the base openings 2016, 2018.

The main housing 2000 may include one or more base peripheral walls 2017, 2019 that protrude from the circumference of the base openings 2016, 2018. The base peripheral wall 2017, 2019 may protrude toward the inside of the main housing 2000 from the circumference forming the base opening 2016, 2018. For example, the base peripheral walls 2017, 2019 may protrude upward from the circumference defining the base opening 2016, 2018. The base peripheral wall 2017, 2019 may include a first base peripheral wall 2017 protruding from the circumference of the first base opening 2016. The base peripheral wall 2017, 2019 may include a second base peripheral wall 2019 protruding from the circumference of the second base opening 2018.

The drain hole 2015 may be a through hole formed in the main housing 2000. The drain hole 2015 may be formed in the lower portion of the main housing 2000. The drain hole 2015 may be formed in the housing base 2010. The drain hole 2015 may communicate the inside of the main housing 2000 with the outside of the main housing 2000. For example, the drain hole 2015 may communicate the inside of the main housing 2000 with the inside of the case 10. The drain hole 2015 may be formed at the edge of the housing base 2010. Although one drain hole 2015 is shown in FIGS. 11 and 12, there may be a plurality of drain holes 2015 in the main housing 2000.

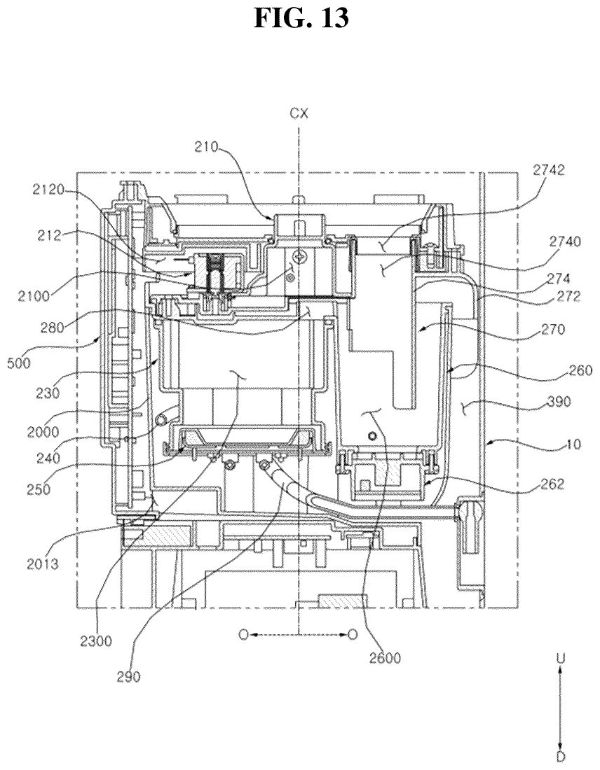

Referring to FIG. 13, the humidifying module 200 in certain implementations of humidifier 1 may include a drain pipe 290 through which residual water stored in the first humidifying water tank 230 is discharged. The drain pipe 290 may be connected to the first humidifying water tank 230. The drain pipe 290 may discharge residual water stored in the first humidifying water tank 230. The remaining water may be discharged to the outside of the case 10 through the drain pipe 290. The drain pipe 290 may be connected to the lower portion of the first humidifying water tank 230. For example, the drain pipe 290 may be connected to the bottom surface of the first humidifying water tank 230.

Referring to FIG. 13, the humidifier 1 may include a first communication port 2013 and a second communication port 2122 that communicate with an internal space 5100 of the display housing 510. The first communication port 2013 may be connected to the internal space 5100 of the display housing 510. The first communication port 2013 may communicate the internal space 5100 of the display housing 510 with the internal space of the case 10. The internal space 5100 of the display housing 510 may be connected to the electrical equipment unit 380 through the first communication port 2013. For example, a wire connected to the electrical equipment unit 380 may be connected to a display substrate 520 through the first communication port 2013. Through this, the display 500 may receive power from a driving signal sent by a power supply module 384 included in the electrical equipment unit 380.

The first communication port 2013 may be located outside the humidifying module 200. The first communication port 2013 may be formed between the humidifying module 200 and the display 500. The first communication port 2013 may be formed between the display housing 510 and the main housing 2000. The housing recess 2012 may be spaced upward from the lower surface of the display housing 510. The first communication port 2013 may be a separation gap between the housing recess 2012 and the lower surface of the display housing 510.

The second communication port 2122 may be connected to the internal space 5100 of the display housing 510. The second communication port 2122 may communicate the internal space 5100 of the display housing 510 with the internal space of the humidifying module 200. The humidifying module 200 may include an accommodation space 2120 in which the first valve 212 is disposed. The second communication port 2122 may communicate the internal space 5100 of the display housing 510 with the accommodation space 2120 of the humidifying module 200. A wire may be connected to the first valve 212 through the second communication port 2122. Through this wire through the second communication port 2122, the first valve 212 may receive power from the power supply module 384 included in the electrical equipment unit 380.

The second communication port 2122 may be formed on the outer wall of the humidifying module 200. The second communication port 2122 may be adjacent to the first valve 212. The second communication port 2122 may face the display substrate 520. A wire wired to the internal space 5100 of the display housing 510 through the first communication port 2013 may be connected to the first valve 212 through the second communication port 2122. The accommodation space 2120 may be formed between the main cover 2020 and the middle tray 400. The second communication port 2122 may define a separation gap between the peripheral wall of the middle tray 400 and the peripheral wall of the main cover 2020.

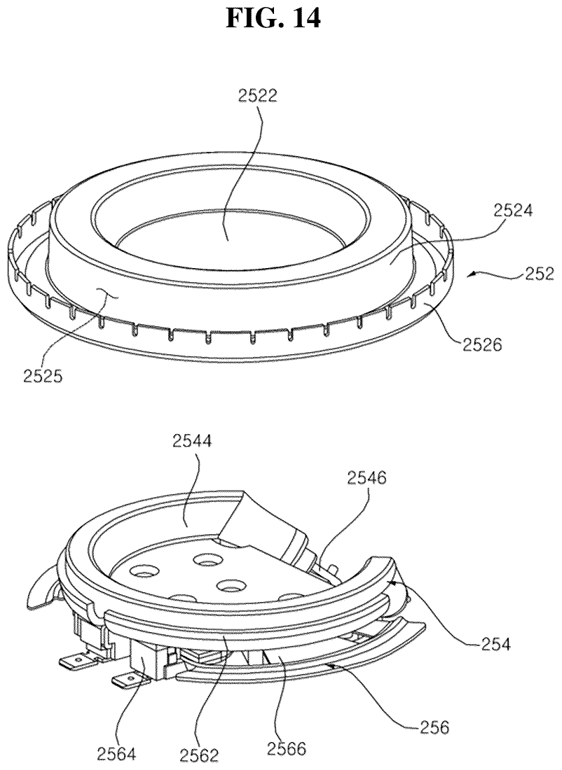

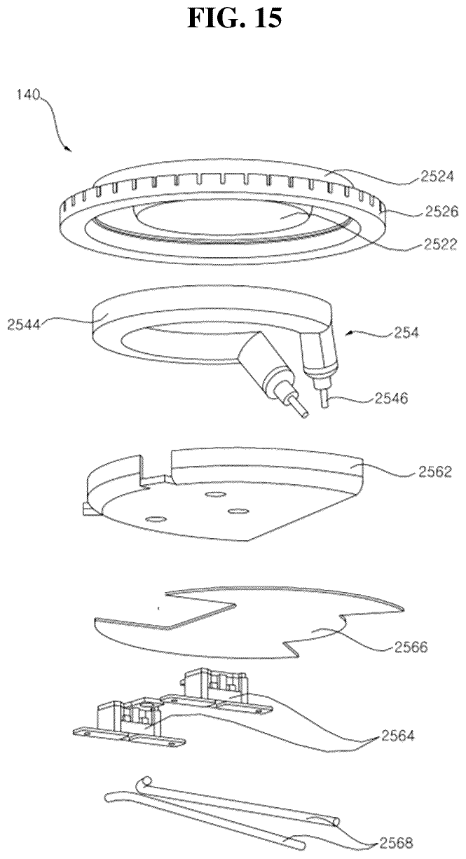

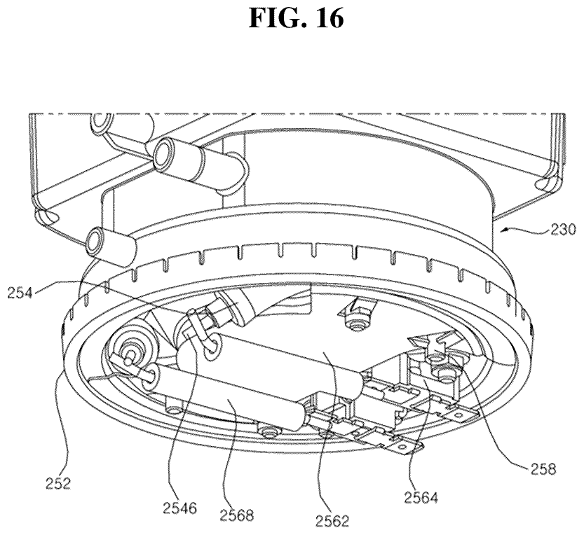

Referring to FIGS. 14 to 16, the heater 250 in certain implementations of the humidifier 1 may include a heater cover 252 defining the bottom surface of the first humidifying water tank 230, a heating element 254 that is joined to the lower side of the heater cover 252 and heats the heater cover 252, a heater base 2562 joined to the lower side of the heating element 254, and a thermostat 2564 that supplies power to the heating element 254 and controls the temperature of the heating element 254.

The heater cover 252 may be coupled to the lower end of the first humidifying water tank wall 232 to define at least a portion of the bottom surface of the first humidifying water tank wall 232. The upper surface of the heater cover 252 may be in contact with water stored in the first chamber 2300. The heating element 254 and the heater base 2562 may be joined to the lower side of the heater cover 252. The heater cover 252 heated by the heating element 254 may heat water stored in the first chamber 2300.

The heater cover 252 may have a substantially circular circumference, and a plurality of vertically extending protrusions and recesses may be formed at concentric positions. A portion of the heater cover 252 may be annular and protrude upward. A portion of the heater cover 252 may protrude to the inside of the first humidifying water tank wall 232 to define a space in which the heating element 254 is accommodated. A portion of the heater cover 252 may be disposed between the water stored in the first chamber 2300 and the heating element 254. Accordingly, the heating element 254 may heat a portion of the heater cover 252 and may not directly contact the water stored in the first chamber 2300.

The heater cover 252 may include a disc-shaped cover base 2522, a cover holder 2524 protruding upward from a circumference of the cover base 2522, and a cover rim 2526 that is defined at a circumference of the cover holder 2524 and coupled to the first humidifying water tank wall 232. The cover base 2522 may be defined as a disk or wall to define the central portion of the heater cover 252. The central portion of the heater base 2562 may be joined to the lower side of the cover base 2522. The central portion of the cover base 2522 and the heater base 2562 may be joined by brazing or other connection method.

The cover holder 2524 may be defined in a ring shape that protrudes upward. The cover holder 2524 may define an annular space in which at least a portion of the heating element 254 may be accommodated. A cast 2544 of the heating element 254 may be accommodated in the annular space of the cover holder 2524. A portion of the heating element 254 may be joined to the inside of the cover holder 2524. The cover holder 2524 and a portion of the heating element 254 may be joined by brazing.

The cover holder 2524 may have a longitudinal cross-section in the radial direction from the center as a curve with the lower side open. At least a portion of the cover holder 2524 may be defined to correspond to a partial shape of the heating element 254 accommodated in the annular space of the cover holder 2524. The cover holder 2524 accommodates a portion of the heating element 254 and may be in direct contact with a portion of the heating element 254. An inner surface of the outer circumferential of the cover holder 2524 may be spaced apart from the outer circumferential surface of a portion of the heating element 254 accommodated in the annular space of the cover holder 2524.

The cover rim 2526 may be defined in a ring or curved shape. The cover rim 2526 may be defined to surround the lower edge of the first humidifying water tank wall 232. The circumferential end of the cover rim 2526 may protrude upward and be coupled to the first humidifying water tank wall 232. Since the cover rim 2526 is not in direct contact with either a heater plate 2566 or the heating element 254, cover rim 2526 may be only slightly heated by relatively low amount.

The heating element 254 may generate heat by receiving power from the thermostat 2564 through the wire 2568. The heating element 254 may heat the heater cover 252 and the heater base 2562. The heater cover 252 may be joined to the upper side of the heating element 254 by brazing or other connection method, and the heater base 2562 may be joined to the lower side of the heating element 254 by brazing or other connection method.

The heating element 254 may be spaced apart from at least a portion of the heater cover 252 having a partial outer circumference defining an annular space. A portion of the heating element 254 may be accommodated in an annular space defined in the heater cover 252 and disposed inside the first humidifying water tank wall 232. The heating element 254 may be disposed below the heater cover 252 defining the bottom surface of the first humidifying water tank wall 232.

Referring to FIGS. 14 to 17, the heating element 254 in certain implementations of humidifier 1 may include a heating device (or heating core) 2543 that generates heat, at least one heating terminal 2546 that receives and supplies power to the heating device 2543, and a cast 2544 wrapping the heating device 2543. The heating device 2543 may generate heat by using electrical energy. The heating terminal 2546 that receives electrical energy may be formed at a distal end of the heating device 2543. The heating device 2543 may be defined in an arc shape. For example, the heating device 2543 may be defined in an arc shape with a central angle of 180 degrees or greater.

The heating terminal 2546 may receive power from the thermostat 2564 through the wire 2568 and transmit the received power to the heating device 2543. A plurality of heating terminals 2546 may be provided in one or both ends of the heating device 2543. The plurality of heating terminals 2546 may extend from both ends of the heating device 2543 and may be inclined downward. For example, the plurality of heating terminals 2546 may be defined to protrude downward from a plane formed by the lower end of the heating device 2543.

The cast 2544 can wrap at least a portion of the heating element 254. The heating terminal 2546 may protrude from the cast 2544. At least a portion of the heating terminal 2546 may not be wrapped in the cast 2544 and may be exposed. The cast 2544 may be defined in an arc shape corresponding to the shape of the heating element 254. For example, the cast 2544 may be formed in an arc shape with a central angle greater than 180 degrees. The cast 2544 may be accommodated inside the cover holder 2524. The upper surface and inner circumferential surface of the cast 2544 may be in contact with the heater cover 252 to heat the heater cover 252. At least a portion of the cast 2544 may be disposed higher than the lower end of the first humidifying water tank wall 232.

The heater base 2562 may be heated by the heating element 254 to heat the cover base 2522 of the heater cover 252. The heater base 2562 may evenly distribute the heat of the heating element 254 to evenly heat the heater cover 252. The heater base 2562 may be defined in a concave, bowl-like shape. The inner circumferential surface of the heater base 2562 may be in contact with the heating element 254, but the outer circumferential surface may be spaced apart from the heater cover 252. The heater plate 2566 may be disposed in the lower side of the heater base 2562.

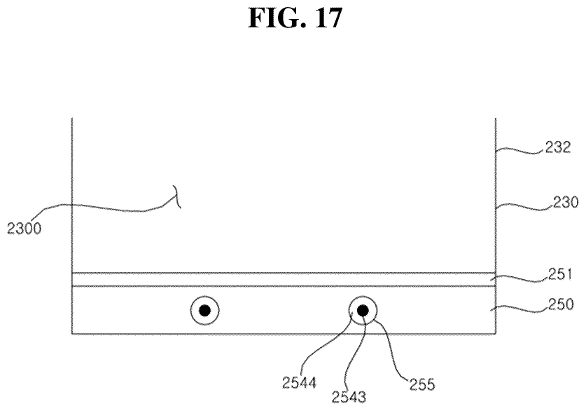

Referring to FIG. 17, the first humidifying water tank 230 in certain implementations of humidifier 1 may include a heater tray 251 disposed above the heater 250. The heater tray 251 may be in contact with water stored in the first chamber 2300. The heater tray 251 may cover the heater 250. The heater tray 251, when heated by the heater 250, may heat water stored in the first chamber 2300. The heater tray 251 may transmit the heat energy of the heater 250 to the water stored in the first chamber 2300. The heater tray 251 may be made of a material that conducts heat. For example, the heater tray 251 may be made of a metal or metal or other material with a relatively high thermal conductivity.

The heater tray 251 may form at least a portion of the bottom surface of the first chamber 2300. The heater tray 251 may be disposed in the first chamber 2300. The heater tray 251 may contact the inner surface of the first humidifying water tank wall 232. The heater tray 251 may be in relatively close contact with the inner surface of the first humidifying water tank wall 232. Accordingly, the water stored in the first chamber 2300 may not directly contact the heater 250. Instead, the heater tray 251 may contact the heater cover 252, and the thermal energy of the heated heater cover 252 may be transmitted to water stored in the first chamber 2300 through the heater tray 251.

The heater tray 251 may be formed of an insulating material. For example, the heater tray 251 may be made of a material with relatively low electrical conductivity. For example, the heater 250 may be made of a ceramic material. Because the heater tray 251 has a relatively low electrical conductivity, the heater tray 251 may prevent any current leaked from the heater 250 from being transmitted to the water stored in the first chamber 2300.

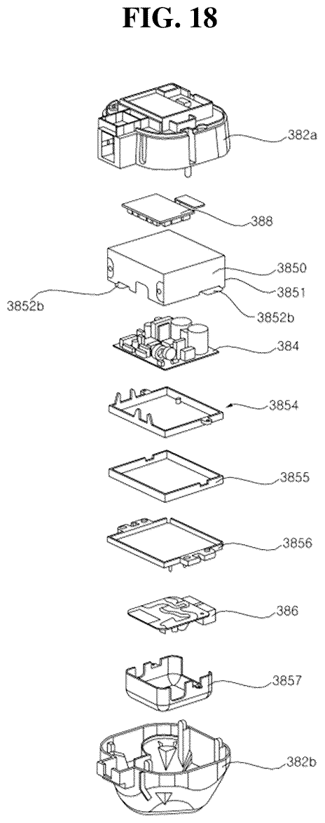

Referring to FIGS. 4 and 18, the electrical equipment unit 380 according to certain implementations of humidifier 1 may include an electrical equipment housing 382 forming an outer shape, at least one substrate (or boards) 384, 386, 388 accommodated in the electrical equipment housing 382, and a control box 385. For example, each of the substrates 384, 386, 388 may be a printed circuit board (PCB) including one or more processing units. The electrical equipment housing 382 may form the outer shape of the electrical equipment unit 380. The electrical equipment housing 382 may be disposed inside the case 10. The electrical equipment housing 382 may be disposed above the blower motor 352. The electrical equipment housing 382 may be disposed in the lower side of the humidifying module 200. The electrical equipment housing 382 may include an internal space in which the one or more substrates 384, 386, 388 may be accommodated.

The electrical equipment housing 382 may include an upper housing 382a and a lower housing 382b. The upper housing 382a may form portion of the electrical equipment housing 382. The lower housing 382b may form the remaining portion of the electrical equipment housing 382. For example, the upper housing 382a may form the upper portion of the electrical equipment housing 382, and the lower housing 382b may form the lower portion of the electrical equipment housing 382.

The one or more substrates 384, 386, 388 may be disposed inside the electrical equipment housing 382. The substrate 384, 386, 388 may be disposed in a space between the upper housing 382a and the lower housing 382b. The substrate 384, 386, 388 may include a first substrate (or first board) 384. The first substrate 384 may supply power to the humidifier 1. The first substrate 384 may be accommodated in the control box 385.

The first substrate 384 may be a power supply module. The power supply module 384 may receive external power and supply electrical energy to the humidifier 1. For example, the power supply module 384 may receive external power and supply electrical energy to the heater 250. Additionally or alternatively, the power supply module 384 may supply electrical energy to at least one of the humidifying module 200, the blower module 300, and the display 500. The power supply module 384 may include a rectifier to convert external AC power.

The control box 385 may be disposed inside the electrical equipment housing 382. The control box 385 may include a box cover 3850 that covers the first substrate 384 and a box base 3855 on which the first substrate 384 is placed. The first substrate 384 may be disposed between the box cover 3850 and the box base 3855. The box cover 3850 may include an internal space in which the first substrate 384 may be accommodated. The box cover 3850 may include a cover peripheral wall 3851 that partitions the internal space of the box cover 3850. The box cover 3850 may be made of an electrically conductive material. For example, the box cover 3850 may be made of a metal material. Through this, leaked current may flow through the control box 385 and be properly directed, such as to a ground.

The control box 385 may include a protruding ground terminal 3852. The ground terminal 3852 may be formed in the box cover 3850. The ground terminal 3852 may be electrically connected, for example, to a power cord or to the humidifying module 200. The control box 385 may include a first ground terminal 3852a extending to one side. The control box 385 may include a second ground terminal 3852b extending to the other side and away from the first ground terminal 3852a. The ground terminal 3852 may extend outward in the horizontal direction. The first ground terminal 3852a and the second ground terminal 3822b may be formed in the box cover 3850.

The electrical equipment unit 380 may include a base plate 3854 disposed inside the control box 385. The first substrate 384 may be fixed to the base plate 3854. The base plate 3854 may be seated on box base 3855. The base plate 3854 may be disposed inside the box cover 3850. The base plate 3854 may be disposed between the box base 3855 and the box cover 3850. The base plate 3854 may be made of an insulating material. For example, the base plate 3854 may be made of Acrylonitrile Butadiene Styrene (ABS) material. Through this configuration in which the base plate 3854 is formed from an insulating material, the leakage current flowing through the control box 385 may not be transmitted to the first substrate 384.

The substrate 384, 386, 388 may include a second substrate 386. The second substrate 386 may convert voltage and current. The second substrate 386 may be accommodated in the control box 385. The second substrate (or second circuit) 386 may be a phase control module. The phase control module 386 may convert the voltage and current input to the humidifying module 200. For example, the phase control module 386 may convert the power input to the heater 250 of the first humidifying water tank 230.

The control box 385 may include a box bracket 3856 on which the box base 3855 may be placed. The second substrate 386 may be fixed to the box bracket 3856. The box bracket 3856 may be coupled to the lower side of the box base 3856. The box bracket 3856 may be made of an insulating material. Through this configuration that includes fixing the second substrate 386 to the box bracket 3856 made of an insulating material, and coupling the box bracket 3856 to the lower side of the box base 3856, the leakage current flowing through the control box 385 may not be transmitted to the second substrate 386.

The control box 385 may include a lower box 3857 fixed to the lower side of the box bracket 3856. The lower box 3857 may cover the second substrate 386. The second substrate 386 may be disposed between the lower box 3857 and the box bracket 3856. The lower box 3857 may be accommodated in the lower housing 382b.

The substrate 384, 386, 388 may include a third substrate (or third circuit) 388. The third substrate 388 may control the operation of the humidifier 1. The third substrate 388 may be fixed to the electrical equipment housing 382. The third substrate 388 may be fixed to the upper housing 382a. The third substrate 388 may be disposed above the control box 385. For example, the third substrate 388 may be disposed between the box cover 3850 and the upper housing 382a.

The third substrate 388 may be a controller 388. The controller 388 may control the operation of the humidifier 1. The controller 388 may control the turn on-off, operating time, humidification amount, and turn on-off and intensity of lighting of the humidifier 1. For example, the controller 388 may be a microcontroller MCU.

The electrical equipment unit 380 may include a communication module that transmits and receives data with an external device. The communication module may include a wireless communication module. The communication module may use wireless communication technologies such as Wi-Fi, Bluetooth, and cellular. The communication module may transmit and receive data to other devices.

The electrical equipment unit 380 may include a sensor that detects information on the indoor space. For example, the sensor may include at least one of a temperature sensor that detects the temperature of the indoor space and a humidity sensor that detects the humidity level of the indoor space.

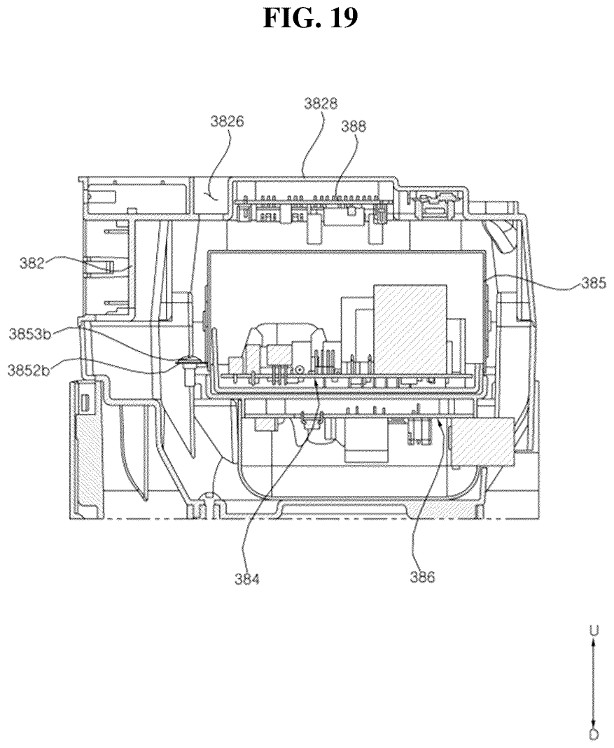

Referring to FIG. 19, the first substrate 384 and the second substrate 386 in certain implementations of the humidifier 1 may be disposed inside the control box 385, and the third substrate 388 may be disposed in the inner surface of the electrical equipment housing 382.

The electrical equipment housing 382 may include a seal recess 3828 in which the third substrate 388 may be disposed. For example, the controller 388 may be disposed in the seal recess 3828. The seal recess 3828 may protrude from the inner surface of the electrical equipment housing 382 in an outward direction. For example, the seal recess 3828 may be formed by recessing upward from the inner upper surface of the electrical equipment housing 382.

The second substrate 386 may be disposed upside down. For example, an outer surface (e.g., processors) of the second substrate 386 may be disposed to face downward, and the rear surface (e.g., a substrate side) of the second substrate 386 may be disposed to face upward. The outer surface of the substrate 384, 386, 388 may be a surface on which substrate components may be disposed. The substrate components may include, for example, a resistor, a capacitor, an inductor, a switch, a relay, a sensor, etc. For example, the second substrate 386 may be fixed to the box bracket 3856 with its outer surface facing downward.

The third substrate 388 may be disposed upside down. For example, the outer surface of the third substrate 388 may be disposed to face downward, and the rear surface of the third substrate 388 may be disposed to face upward.

The electrical equipment housing 382 may include a wire hole 3826 through which wires pass. The wire hole 3826 may be a through hole formed in the upper surface of the electrical equipment housing 382. The wire passing through the wire hole 3826 may connect the electrical equipment unit 380 and the display 500. In addition, the wire passing through the wire hole 3826 may connect the electrical equipment unit 380 and the humidifying module 200. For example, a wire passing through the wire hole 3826 may connect the controller 388 and the first valve 212 of the humidifying module 200.

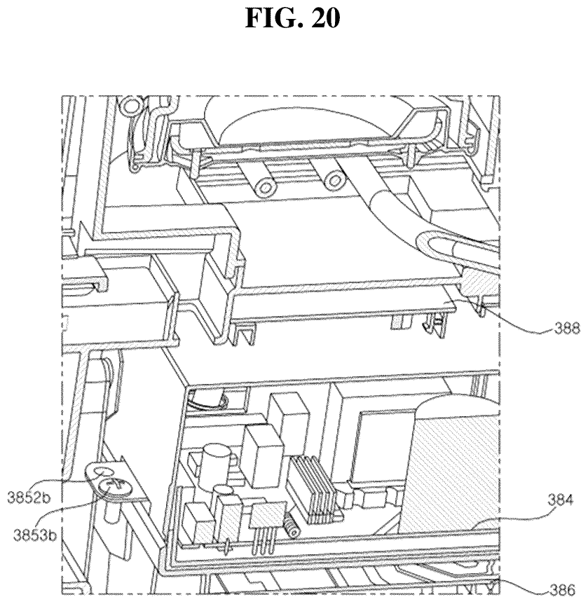

Referring to FIGS. 19 and 20, the humidifier 1 in certain implementations of humidifier 1 may include a ground screw 3853 fastened to the ground terminal 3852. The ground screw 3853 may fix the wire connected to the ground terminal 3852. The ground screw 3853 may include a first ground screw 3853a that fixes the wire connected to the heater terminal 258 to the first ground terminal 3852a. The ground screw 3853 may include a second ground screw 3853b that fixes the power cord (or external power supply) to the second ground terminal 3852b. For example, the wire connected to the heater terminal 258 may be fixed to the first ground terminal 3852a by the first ground screw 3853a. In addition, the power cord may be fixed to the second ground terminal 3852b by the second ground screw 3853b.

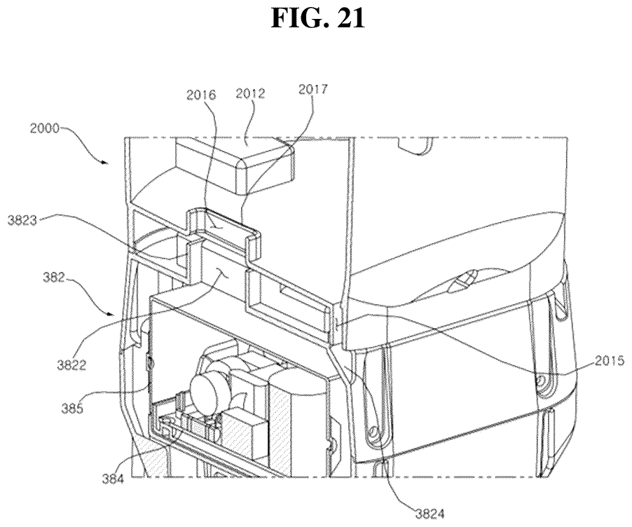

Referring to FIG. 21, the main housing 2000 in certain implementations of humidifier 1 may have a drain hole 2015 through which residual water is discharged, and the electrical equipment housing 382 may include a drain slope 3824 which is located in the lower side of the drain hole 2015 to guide residual water to the outer wall. The drain slope 3824 may be formed on the outer wall of the electrical equipment housing 382. The drain slope 3824 may be inclined downward in an outward direction. For example, the drain slope 3824 may become lower in an outward, downstream direction. The remaining water drained through the drain hole 2015 may be guided to the outer wall of the electrical equipment housing 382 along the drain slope 3824. The remaining water guided to the outer wall of the electrical equipment housing 382 may fall into the blowing flow path 390. The drain slope 3824 may include a plurality of drain slopes 3824 corresponding to the plurality of drain holes 2015.

Similarly, the drain hole 2015 may extend downward. The circumference forming the drain hole 2015 may extend downward. The drain hole 2015 extending downward may be connected to the drain slope 3824 and guide residual water.

The electrical equipment housing 382 may include a seal opening 3822 corresponding to the base opening 2016, 2018. The seal opening 3822 may be a through hole formed in the electrical equipment housing 382. The seal opening 3822 may be formed in the upper surface of the electrical equipment housing 382. The seal opening 3822 may be connected to base opening 2016, 2018. The wire connecting the humidifying module 200 and the electrical equipment unit 380 may be disposed in the seal opening 3822 and the base opening 2016, 2018. The seal opening 3822 may include a first seal opening 3822 corresponding to the first base opening 2016.

The electrical equipment housing 382 may include a seal peripheral wall 3823 protruding from the circumference of the seal opening 3822. The seal peripheral wall 3823 may protrude from a circumference defining the seal opening 3822 toward the base opening 2016, 2018. The direction in which the seal peripheral wall 3823 protrudes may correspond to the direction in which the at least one base peripheral wall 2017, 2019 protrudes. The seal peripheral wall 3823 may include a first seal peripheral wall 3823 protruding from the circumference of the first seal opening 3822. For example, the first seal peripheral wall 3823 may protrude upward from the first seal opening.

The control box 385 may cover the first substrate 384 at the lower side of the seal opening 3822. The first substrate 384 may be accommodated in the control box 385. For example, the control box 385 may cover and protect the power supply module 384 from moisture.

Referring to FIGS. 1 to 21, a humidifier according to one aspect of the present disclosure may include: a first humidifying water tank which heats water; and an electrical equipment unit electrically connected to the first humidifying water tank, wherein the first humidifying tank may include a heater which may be disposed in a lower portion of the first humidifying water tank, and heats water, wherein the electrical equipment unit may include: a first substrate which supplies power to the heater; and a control box which accommodates the first substrate, and may be electrically connected to a power cord and the heater, respectively.

According to another aspect of the present disclosure, the humidifier further may include a second humidifying water tank which receives water from the first humidifying water tank and generates humidified air. According to another aspect of the present disclosure, the heater may include a heater terminal electrically connected to the control box.

According to another aspect of the present disclosure, the heater may include: a heating element which generates heat; a heater cover which covers an upper side of the heating element; and a heater base which may be coupled to a lower side of the heating element, and in which the heater terminal may be disposed. According to another aspect of the present disclosure, the heating element may include: a heating device which generates heat by using electrical energy; and a cast which surrounds the heating device, and may be formed of a metal material.

According to another aspect of the present disclosure, the heater terminal protrudes to a lower side of the heater base. According to another aspect of the present disclosure, the first humidifying tank may include a heater tray which covers the heater, and forms a bottom surface inside the first humidifying water tank, wherein the heater tray may be formed of ceramic material.

According to another aspect of the present disclosure, the control box may include: a box base on which the first substrate may be seated; and a box cover which may be coupled to the box base, and covers the first substrate. According to another aspect of the present disclosure, the box cover may include: a first ground terminal which extends to one side, and may be electrically connected to the heater; and a second ground terminal which extends to the other side, and may be electrically connected to the power cord.

According to another aspect of the present disclosure, a wire connected to the heater may be screwed to the first ground terminal, and the power cord may be screwed to the second ground terminal. According to another aspect of the present disclosure, the control box may include a base plate to which the first substrate may be fixed, and which may be seated on the box base, wherein the base plate may be formed of insulating material.

According to another aspect of the present disclosure, the electrical equipment unit may include a second substrate which converts an electrical signal, the control box may include a box bracket which may be coupled to a lower side of the box base, and to which the second substrate may be fixed, wherein the box bracket may be formed of insulating material. According to another aspect of the present disclosure, the first substrate may be fixed to the base plate so that a surface faces upward, and the second substrate may be fixed to the box bracket so that a surface faces downward.

According to another aspect of the present disclosure, the electrical equipment unit may include an electrical equipment housing which accommodates the control box, and may be disposed in a lower side of the first humidifying water tank, wherein the electrical equipment housing may include a seal opening which may be opened upwardly. According to another aspect of the present disclosure, the humidifier further may include a main housing accommodating the first humidifying water tank, wherein the main housing may include a base opening corresponding to the seal opening.

Referring to FIGS. 1 to 21, the humidifier according to one aspect of the present disclosure may include: a first humidifying water tank which heats water; and an electrical equipment unit which may be electrically connected to the first humidifying water tank, wherein the first humidifying water tank may include: a heater which may be disposed in a lower portion of the first humidifying water tank, and heats water; and a heater tray which covers the heater, and forms a bottom surface inside the first humidifying water tank, wherein the heater tray may be formed of insulating material. According to another aspect of the present disclosure, the heater tray may be formed of ceramic material.

Referring to FIGS. 1 to 21, the humidifier according to one aspect of the present disclosure may include: a humidifying water tank which generates humidified air; and an electrical equipment unit which may be electrically connected to the humidifying water tank, wherein the electrical equipment unit may include: a first substrate which supplies power to the humidifying water tank; and a control box in which the first substrate may be accommodated, wherein the control box may include: a first ground terminal which extends to one side and may be electrically connected to the humidifying water tank; and a second ground terminal which extends to the other side and may be electrically connected to a power cord.

According to another aspect of the present disclosure, the humidifying water tank may include a first humidifying water tank which heats water, wherein the first humidifying water tank may include a heater which may be disposed in a lower portion of the first humidifying water tank, and heats water, wherein the first ground terminal may be connected to the heater. According to at least one of the embodiments of the present disclosure, due to the control box that electrically connects the heater and the power cord, the current leaked from the heater may be transmitted to the ground through the power cord, thereby improving the safety of the humidifier.

According to at least one of the embodiments of the present disclosure, due to the heater terminal protruding to the lower side of the first humidifying water tank, it may be connected to the control box located below while being spaced away from the flow path of the humidified air, thereby reducing the risk of short circuit in the humidifier and improving a safety. According to at least one of the embodiments of the present disclosure, the heater may include a heater cover that covers the heating element and a heater base, and may uniformly heat and sterilize the stored water by using heat emitted from the heating element. Through this, the humidification performance and sterilization performance of the humidifier may be improved.

According to at least one of the embodiments of the present disclosure, the heating element may include a heating device that generates heat and a cast made of a metal material that surrounds it, thereby improving the thermal conductivity of the heating element. Through this design, the sterilization performance and humidification performance of the humidifier can be improved.

According to at least one of the embodiments of the present disclosure, a heater tray made of a ceramic material forms the bottom surface of the first chamber, so that the heat energy generated by the heater may be transferred to the water stored in the first chamber, but the leaked current may not be transferred. Through this configuration, the risk of short circuit of the humidifier can be reduced, and safety and durability of the humidifier can be improved.

According to at least one of the embodiments of the present disclosure, the power cord and the ground wire can be stably connected due to the first ground terminal and the second ground terminal formed in the control box. According to at least one of the embodiments of the present disclosure, the first substrate that supplies power may be electrically disconnected from the control box through which leaked current flows, thereby improving the stability and durability of the humidifier.

According to at least one of the embodiments of the present disclosure, the stability and durability of the humidifier can be improved, by electrically disconnecting the second substrate that converts the electrical signal from the control box through which leaked current flows. According to at least one of the embodiments of the present disclosure, the ground wire connecting the control box and the humidifying water tank through the base opening and the seal opening may be disposed to be spaced apart from the flow path of humidified air. Through this, the safety and durability of the humidifier can be improved.

The disclosure has been made in view of the above problems, and may provide a humidifier with improved safety. The disclosure may further provide a humidifier with improved durability. The disclosure may further provide a humidifier with a reduced risk of short circuiting. The disclosure may further provide a humidifier with improved usability. The disclosure may further provide a humidifier with improved hygienic performance. The disclosure may further provide a humidifier with improved humidification efficiency. The disclosure may further provide a humidifier with improved sterilization performance.

In accordance with an aspect of the present disclosure, a humidifier may include: a first humidifying water tank which heats water; and an electrical equipment unit electrically connected to the first humidifying water tank, wherein the first humidifying tank may include a heater which may be disposed in a lower portion of the first humidifying water tank, and heats water, wherein the electrical equipment unit may include: a first substrate which supplies power to the heater; and a control box which accommodates the first substrate, and may be electrically connected to a power cord and the heater, respectively, so that the heater may be electrically connected to a power cord.

The humidifier further may include a second humidifying water tank which receives water from the first humidifying water tank and generates humidified air. The heater may include a heater terminal electrically connected to the control box, so that current leaking in the heater can escape through a heater terminal.

The heater may include: a heating element which generates heat; a heater cover which covers an upper side of the heating element; and a heater base which may be coupled to a lower side of the heating element, and in which the heater terminal may be disposed. The heating element may include: a heating device which generates heat by using electrical energy; and a cast which surrounds the heating device, and may be formed of a metal material, so that the cast can transfer thermal energy generated by the heating element.

The heater terminal protrudes to a lower side of the heater base, so that it can be connected to a control box located in a lower side of the first humidifying water tank. The first humidifying tank may include a heater tray which covers the heater, and forms a bottom surface inside the first humidifying water tank, and the heater tray may be formed of ceramic material.

The control box may include: a box base on which the first substrate may be seated; and a box cover which may be coupled to the box base, and covers the first substrate, thereby protecting the first substrate from moisture. The box cover may include: a first ground terminal which extends to one side, and may be electrically connected to the heater; and a second ground terminal which extends to the other side, and may be electrically connected to the power cord, thereby electrically connecting the heater and the power cord. A wire connected to the heater may be screwed to the first ground terminal, and the power cord may be screwed to the second ground terminal.

The control box may include a base plate to which the first substrate may be fixed, and which may be seated on the box base, wherein the base plate may be formed of insulating material, so that the leaked current may not flow to the first substrate. The electrical equipment unit may include a second substrate which converts an electrical signal, and the control box may include a box bracket which may be coupled to a lower side of the box base, and to which the second substrate may be fixed, wherein the box bracket may be formed of insulating material, so that the leaked current may not flow to the second substrate.

The first substrate may be fixed to the base plate so that a surface faces upward, and the second substrate may be fixed to the box bracket so that a surface faces downward, so that residual water may not accumulate on the second substrate. The electrical equipment unit may include an electrical equipment housing which accommodates the control box, and may be disposed in a lower side of the first humidifying water tank, wherein the electrical equipment housing may include a seal opening which may be opened upwardly, so that a wire connecting the heater terminal and the ground terminal may be disposed in the seal opening. The humidifier further may include a main housing accommodating the first humidifying water tank, wherein the main housing may include a base opening corresponding to the seal opening, so that a wire connecting the heater terminal and the ground terminal may be disposed in the base opening.

In accordance with another aspect of the present disclosure, a humidifier may include: a first humidifying water tank which heats water; and an electrical equipment unit which may be electrically connected to the first humidifying water tank, wherein the first humidifying water tank may include: a heater which may be disposed in a lower portion of the first humidifying water tank, and heats water; and a heater tray which covers the heater, and forms a bottom surface inside the first humidifying water tank, wherein the heater tray may be formed of insulating material, so that current leaking from the heater may not be transmitted to the stored water. The heater tray may be formed of ceramic material.

In accordance with another aspect of the present disclosure, a humidifier may include: a humidifying water tank which generates humidified air; and an electrical equipment unit which may be electrically connected to the humidifying water tank, wherein the electrical equipment unit may include: a first substrate which supplies power to the humidifying water tank; and a control box in which the first substrate may be accommodated, wherein the control box may include: a first ground terminal which extends to one side and may be electrically connected to the humidifying water tank; and a second ground terminal which extends to the other side and may be electrically connected to a power cord, so that the humidifying water tank and the power cord may be electrically connected.

The humidifying water tank may include a first humidifying water tank which heats water, wherein the first humidifying water tank may include a heater which may be disposed in a lower portion of the first humidifying water tank, and heats water, and the first ground terminal may be connected to the heater, so that the heater and the power cord may be electrically connected.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments may be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A humidifier, comprising:
a first tank which holds water; and
an electrical equipment unit electrically connected to the first tank,
wherein the first tank includes a heater which is disposed in a lower region of the first tank and heats the water, and
wherein the electrical equipment unit includes:
a first board which supplies power to the heater; and
a control box which accommodates the first board, and is electrically connected to a power cord and the heater, respectively.

2. The humidifier of claim 1, further comprising a second tank which receives water from the first tank and generates humidified air with the water received from the first tank.

3. The humidifier of claim 1, wherein the heater includes a heater terminal electrically connected to the control box.

4. The humidifier of claim 3, wherein the heater includes:
a heating element which generates heat;
a heater cover which covers an upper side of the heating element; and
a heater base which is coupled to a lower side of the heating element, and in which the heater terminal is disposed.

5. The humidifier of claim 4, wherein the heating element includes:
a heating core which generates heat by using electrical energy; and
a cast which surrounds the heating core, and is formed of a metal material.

6. The humidifier of claim 4, wherein the heater terminal protrudes downward from the heater base.

7. The humidifier of claim 3,
wherein the first humidifying tank includes a heater tray which covers at least a portion of the heater, and forms at least a portion of a bottom inner surface of the first tank, and
wherein the heater tray is formed of a ceramic material.

8. The humidifier of claim 1, wherein the control box includes:
a box base on which the first board is seated; and
a box cover which is coupled to the box base, and covers the first board.

9. The humidifier of claim 8, wherein the box cover includes:
a first ground terminal which extends from a first side of the box cover, and is electrically connected to the heater; and
a second ground terminal which extends from a second side of the box cover, and is electrically connected to the power cord.

10. The humidifier of claim 9,
wherein a wire connected to the heater is coupled by a first screw to the first ground terminal,
wherein the power cord is coupled by a second screw to the second ground terminal.

11. The humidifier of claim 8,
wherein the control box includes a base plate to which the first board is fixed, and which is seated on the box base, and
wherein the base plate is formed of an insulating material.

12. The humidifier of claim 11,
wherein the electrical equipment unit includes a second board which converts an electrical signal,
wherein the control box includes a box bracket which is coupled to a lower side surface of the box base, and to which the second board is fixed, and
wherein the box bracket is formed of an insulating material.

13. The humidifier of claim 12,
wherein the first board is fixed to the base plate so that one or more processing units included in the first board are provided on an upper surface of a substrate included in the first board, and
wherein the second board is fixed to the box bracket so that one or more processing units included in the second board are provided on a lower surface of a substrate included in the second board.

14. The humidifier of claim 1,
wherein the electrical equipment unit includes an electrical equipment housing which accommodates the control box, and is disposed lower than the first tank, and
wherein an upper surface of the electrical equipment housing includes a seal opening.

15. The humidifier of claim 14, further comprising a main housing accommodating the first tank,
wherein the main housing includes a base opening corresponding to the seal opening of the electrical equipment housing.

16. A humidifier comprising:
a tank;
a heater which is disposed in a lower wall of the tank and heats water in the tank; and
a heater tray which covers at least a portion of the heater and forms at least a portion of a bottom surface inside the tank,
wherein the heater tray is formed of an insulating material.

17. The humidifier of claim 16, wherein the heater tray is formed of a ceramic material.

18. A humidifier, comprising:
at least one water tank which generates humidified air;
a power supply which supplies power to the at least one water tank; and
a control box in which the power supply is accommodated,
wherein the control box includes:
a first ground terminal which extends to a first side of the control box and is electrically connected to the at least one water tank; and
a second ground terminal which extends to a second side of the control box and is electrically connected to an external power supply.

19. The humidifier of claim 18,
wherein the at least one water tank includes a first tank having a heater which is disposed in a lower region of the first tank and that heats water in the first tank, and
wherein the first ground terminal is electrically connected to the heater.

20. The humidifier of claim 19,
wherein the at least one water tank includes a second tank that receives water from the first tank and includes a vibrator that atomizes water in the second tank, and
wherein the first ground terminal is electrically connected to the vibrator.
